(19) United States
(12) Patent Application Publication
(10) Pub. No.: US 2013/0251151 A1
(43) Pub. Date: Sep. 26, 2013

(54) WIRELESS COMMUNICATION DEVICE, WIRELESS COMMUNICATION SYSTEM, AND NETWORK DEVICE

(71) Applicant: BUFFALO INC., Nagoya-shi (JP)

(72) Inventor: Daisuke YAMADA, Nagoya-shi (JP)

(21) Appl. No.: 13/897,263

(22) Filed: May 17, 2013

Related U.S. Application Data
(63) Continuation of application No. 12/851,374, filed on Aug. 5, 2010.

(30) Foreign Application Priority Data
Aug. 6, 2009 (JP) 2009-183602

(51) Int. Cl. H04W 12/04

(52) U.S. Cl. CPC H04W 12/04
USPC 380/270

(57) ABSTRACT

The wireless communication system 1000 includes an access point 100, a wireless terminal 200A, and a wireless terminal 200B. The access point 100 and the wireless terminal 200A each uniquely generate a shared key using an identical conversion function on the basis of unique information read from an RFID tag 310A of an RFID card 300A, and then generate a common encryption key on the basis of the shared key. The access point 100 and the wireless terminal 200B each uniquely generate a shared key using an identical conversion function on the basis of unique information read from an RFID tag 310B of an RFID card 300B, and then generate a common encryption key on the basis of the shared key.

### CROSS REFERENCE TO RELATED APPLICATIONS

This application is a Continuation of U.S. patent application Ser. No. 12/851,374 filed Aug. 5, 2010, which claims benefit of priority to Japanese Application No. 2009-183602 filed Aug. 6, 2009, both of which are hereby incorporated by reference.

### TECHNICAL FIELD

The present invention relates to a wireless communication device, a wireless communication system, and a network device.

### RELATED ART

Wireless LANs (Local Area Networks) have become widespread in recent times. In a wireless LAN, communications between wireless communication devices communicating with one another, for example, a wireless LAN access point (hereinafter termed simply the access point) and a wireless terminal, are encrypted in order to prevent unauthorized access to the wireless LAN, and to keep communications from being leaked to third parties. In encrypted communications, a common key system is employed as the encryption system, and this requires setting up a common encryption key on each wireless communication device, or carrying out authentication using an external server. However, setup of the common key can be cumbersome or difficult for users whose are not familiar with wireless communication devices. Moreover, it is necessary to prevent disclosure of the encryption key to third parties. In this regard, a number of different technologies have been proposed for setting up a common encryption key in wireless communication devices such as access points and wireless terminals, while at the same time maintaining security.

However, one of prior art requires a wired connection in order for the encryption key to be transferred from the access point to the wireless terminal. Some of other prior arts require separate provision of a special RFID (Radio Frequency Identification) tag (IC card) for storing the information used in setting up encrypted communication, or an RFID writer for writing to the RFID tag the information used to set up encrypted communication. The need to provide an RFID writer or a special RFID card for setting up encrypted communication represents a significant cost burden for the user. This problem is not limited to set up of an encryption key in wireless communication devices, and may be encountered during setup of authentication information used in a network device for authentication of other network devices.

An advantage of some aspects of the invention is to provide a technique enabling easy setup of an encryption key in a wireless communication device for the purpose of encrypted communication with other wireless communication devices, while minimizing the cost burden on the user and maintaining security.

Another advantage of some aspects of the invention is to provide a technique enabling easy setup of authentication information in a network device for the purpose of authentication of other network devices, while minimizing the cost burden on the user and maintaining security.

The entire disclosure of Japanese patent application No. 2009-183602, of Buffalo inc. is hereby incorporated by reference into this document.

### SUMMARY

The present invention is addressed to attaining the above objects at least in part according to the following aspects of the invention.

According to one aspect of the invention, there is provided:

a wireless communication device comprising:

an acquisition portion which acquires prescribed information read from an RFID (Radio Frequency Identification) tag that retains unique information;

a shared key generation portion which uniquely generates based on the prescribed information a shared key serving as a basis to generate an encryption key for use in encrypted communication with another wireless communication device;

a shared key storage portion which stores the shared key;

an authentication process portion which carries out authentication between the wireless communication device and the another wireless communication device, using the shared key as authentication information;

an encryption key generation portion which generates the encryption key based on at least the shared key, in the event that authentication by the authentication process portion is successful; and

a communication portion which carries out encrypted communication using the encryption key.

In addition to embodiment as a wireless communication device, a wireless communication system, and a network device as described above, the present invention may be embodied as an invention for a method of setting up an encryption key in a wireless communication device or a method of setting up authentication information in a network device. Additional possible aspects include a computer program for accomplishing the above, or a recording medium having the program recorded thereon. Any of supplemental elements described above may be adopted in these respective aspects as well.

Where the present invention is provided as a computer program or a recording medium having the computer program recorded thereon, it may constitute the entire program for controlling operations of the wireless communication device, or only that portion used to carry out the functions of the present invention. Various computer-readable media may be employed as the recording medium, such as a flexible disk, CD-ROM, DVD-ROM, magnetooptical disk, IC card, ROM cartridge, printed matter imprinted with symbols such as a bar code, computer internal memory devices (memory such as RAM and ROM), and external memory devices.

These and other objects, features, aspects, and advantages of the present invention will become more apparent from the following detailed description of the preferred embodiments with (/and) the accompanying drawings.

### BRIEF DESCRIPTION OF THE DRAWINGS

FIG. 1 depicts general features of a wireless communication system 1000 in a first embodiment of the invention;

FIG. 2 depicts general features of an access point 100;

FIG. 3 depicts general features of a wireless terminal 200A;

FIG. 4 is a flowchart depicting the flow of a shared key setup process;

FIG. 5 is a flowchart depicting the flow of an encryption key setup process;

FIG. 6 depicts general features of an access point 100A;

FIG. 7 is a flowchart depicting the flow of a shared key setup process;

FIG. 8 depicts general features of an access point 100B;

FIG. 9 is a flowchart depicting the flow of a shared key setup process;

FIG. 10 depicts general features of a wireless communication system as a modified example; and

FIG. 11 depicts general features of a wireless communication system as a modified example.

### DESCRIPTION OF EXEMPLARY EMBODIMENT

The aspects of the invention are illustrated through the following description of the embodiments.

### A. First Embodiment:

### A1. Wireless Communication System Features:

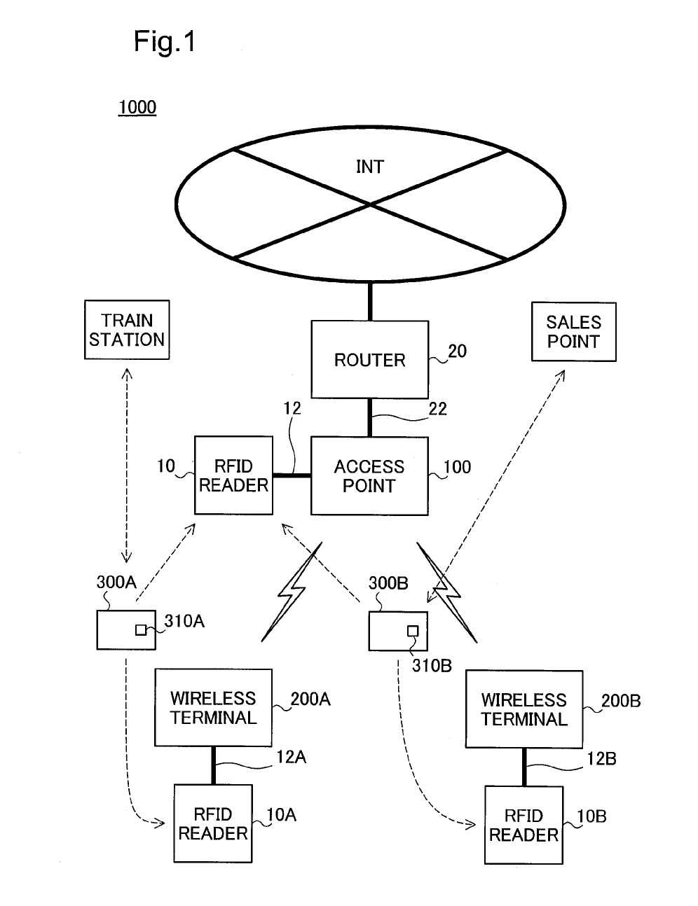

FIG. 1 depicts general features of a wireless communication system 1000 in a first embodiment of the invention. As illustrated, the wireless communication system 1000 of the present embodiment includes a wireless LAN (Local Area Network) having an access point 100, a wireless terminal 200B, and a wireless terminal 200C. A router 20 is connected to the access point 100 by an Ethernet ™ cable 22, and the access point 100 connects to the internet INT via the router 20. The wireless communication system 1000 of the present embodiment can be deployed in a private residence, in an enterprise or “hot spots” provided by NTT Communications Corporation.

The access point 100 and the wireless terminals 200A, 200B communicate by encrypted communication using a common key encryption system. Thus, it is necessary to set up a common encryption key for the access point 100 and the wireless terminal 200A. It is also necessary to set up a common encryption key for the access point 100 and the wireless terminal 200B. The encryption key used for encrypted communication between the access point 100 and the wireless terminal 200A may be the same as or different from the encryption key used for encrypted communication between the access point 100 and the wireless terminal 200B. Encryption keys should not be divulged to any third party. In the wireless communication system 1000 of the present embodiment, setting of the encryption key in the access point 100 and the wireless terminals 200A, 200B is carried out using the RFID (Radio Frequency Identification) tag provided to an existing RFID card.

In the present embodiment, the existing RFID cards employ the FeliCa ™ system based on the NFC (Near Field Communication) standard. The FeliCa system is purchased beforehand so that wireless LAN users can access existing services (e.g. a prepaid electronic debit service) using FeliCa. In the FeliCa system, the RFID tags are passive RFID tags; each RFID tag contains as unique information a unique number exclusively assigned to the individual RFID (a manufacture ID (IDm), a manufacture parameter (PMm)), as well as information that can be updated each time the service is used (updated information). Examples of such RFID tags include RFID tags in chip-embedded train tickets, electronic debit cards, club membership cards, retailer rewards cards, employee ID cards, and cell phones.

The mechanism for setting up an encryption key in the access point 100 and the wireless terminals 200A, 200B using an existing RFID card is as follows. Each of the RFID readers 10, 10A, 10B described below is relatively inexpensive device without a write function.

The RFID reader 10 is connected to the access point 100 through a USB cable 12. When an RFID card 300A is held over a reading portion, the RFID reader 10 reads the unique information inclusive of the unique number and the update information from an RFID tag 310A provided to the RFID card 300A. This RFID card 300A is a chip-embedded train ticket, and each time that the holder makes a trip the update information included in the unique information that is stored in the RFID tag 310A is updated by an RFID writer located at the railway station. When an RFID card 300B is held over a reading portion, the RFID reader 10 reads the unique information inclusive of the unique number and the update information from an RFID tag 310B provided to the RFID card 300B. This RFID card 300B is an electronic debit card, and each time that that electronic funds are used the update information included in the unique information that is stored in the RFID tag 310B is updated by an RFID writer located at the point of sale. On the basis of the unique information read by the RFID reader 10, the access point 100 uniquely generates a shared key serving as a basis for generating an encryption key. In the present embodiment, the access point 100 uses a prescribed conversion function to compute a shared key from the unique information.

The RFID reader 10A is connected to the wireless terminal 200A through a USB cable 12A. When for example the RFID card 300A is held over a reading portion, the RFID reader 10A reads the unique information inclusive of the unique number and the update information from the RFID tag 310A provided to the RFID card 300A. Then, on the basis of the unique information read by the RFID reader 10A, and using the same conversion function as the access point 100, the wireless terminal 200A uniquely generates a shared key serving as a basis for generating an encryption key. The same shared key is thereby set up in the access point 100 and the wireless terminal 200A.

Subsequently, using this same shared key, the access point 100 and the wireless terminal 200A respectively generate a common encryption key, and set this encryption key as the encryption key to be used in encrypted communication between them.

The RFID reader 10B is connected to the wireless terminal 200B through a USB cable 12B. When for example the RFID card 300B is held over a reading portion, the RFID reader 10B reads the unique information inclusive of the unique number and the update information from the RFID tag 310B provided to the RFID card 300B. Then, on the basis of the unique information read by the RFID reader 10B, and using the same conversion function as the access point 100, the wireless terminal 200B uniquely generates a shared key serving as a basis for generating an encryption key. The same shared key is thereby set up in the access point 100 and the wireless terminal 200B.

Subsequently, using this same shared key, the access point 100 and the wireless terminal 200B respectively generate a common encryption key, and set this encryption key as the encryption key to be used in encrypted communication between them.

Through the mechanism described above, the encryption key is set up in the access point 100 and in the wireless terminals 200A, 200B.

### A2. Access Point Features:

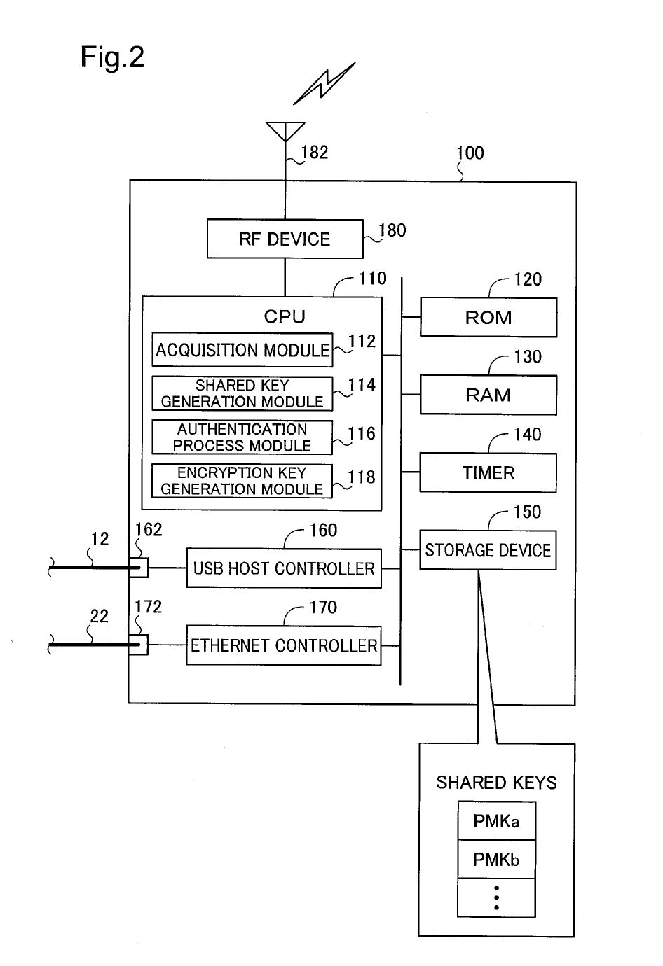

FIG. 2 depicts general features of the access point 100. As shown, the access point 100 includes a CPU 110, a ROM 120, a RAM 130, a timer 140, a storage device 150, a USB host controller 160, a USB port 162, an Ethernet controller 170, a WAN port 172, an RF device 180, and an antenna 182.

The USB host controller 160 controls operation of the RFID reader 10 via a USB cable 12 that is connected to the USB port 162. Via an Ethernet cable 22 connected to the WAN port 172 and through the internet INT, the Ethernet controller 170 communicates with various servers, not shown, that are also connected to the internet INT. The RF device 180 and the antenna 182 communicate wirelessly with the wireless terminals 200A, 200B. The RF device 180 sends and receives wireless signals through the antenna 182.

The CPU 110 controls the entire access point 100. By loading and executing a computer program stored in the ROM 120, the CPU 110 also functions as an acquisition module 112, a shared key generation module 114, an authentication process module 116, and an encryption key generation module 118, and carries out a shared key generation process and an encryption key generation process, discussed later.

The acquisition module 112 acquires the unique information inclusive of the unique number and update information, that was read by the RFID reader 10. The shared key generation module 114 uniquely generates a shared key (PMK: Pairwise Master Key) on the basis of the unique information acquired by the acquisition module 112. In the present embodiment, the acquisition module 112 acquires a prescribed number of bits (≧512 bits) of unique information, and the shared key generation module 114, using a prescribed conversion function, uniquely computes from the unique information a shared key of 512-bit key length. The shared key generated by the shared key generation module 114 is then saved to the storage device 150. As shown in FIG. 2, a shared key PMKa and a shared key PMKb are saved. The shared key PMKa is generated on the basis of unique information read from the RFID tag 310A of the RFID card 300A. The shared key PMKb is generated on the basis of unique information read from the RFID tag 310B of the RFID card 300B. A rewriteable, nonvolatile memory (e.g. flash memory) may be used as the storage device 150 for example.

Prior to encrypted communication between the access point 100 and the wireless terminal 200A or 200B, the authentication process module 116 exchanges packets containing the shared key with the wireless terminal 200A or 200B, and performs an authentication process using the shared key as authentication information. In case where the access point 100 and the wireless terminal 200A or 200B communicating with the access point 100 possess identical shared keys, authentication is successful. When authentication is successful, the encryption key generation module 118 generates an encryption key on the basis of (i) the shared key identical to the shared key belonging to the supplicant wireless terminal 200A or 200B, (ii) the MAC address and the SSID (Service Set Identifier) of the access point 100, or the like.

### A3. Wireless Terminal Features:

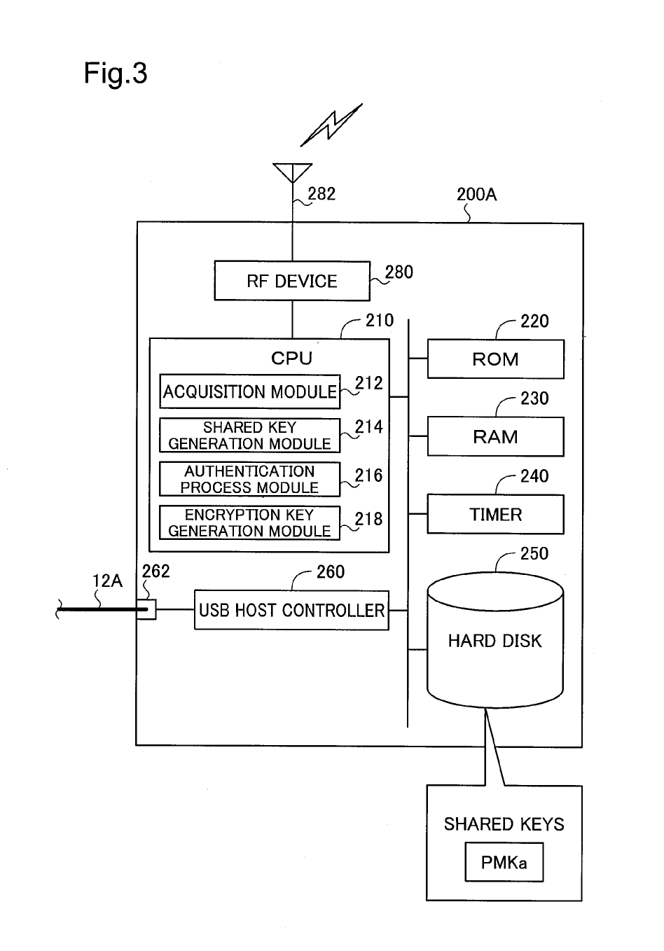

FIG. 3 depicts general features of the wireless terminal 200A. The features of the wireless terminal 200B are identical to the features of the wireless terminal 200A. The wireless terminal 200A, 200B is created, for example, by installing a wireless LAN card in a personal computer. As illustrated, the wireless terminal 200A includes a CPU 210, a ROM 220, a RAM 230, a timer 240, a hard disk 250, a USB controller 260, a USB port 262, an RF device 280, and an antenna 282.

The USB host controller 260 controls operation of the RFID reader 10A via a USB cable 12A that is connected to the USB port 362. The RF device 280 and the antenna 282 communicate wirelessly with the access point 100. The RF device 280 sends and receives wireless signals through the antenna 282.

The CPU 210 controls the entire wireless terminal 200A. By loading and executing a computer program stored in the ROM 220 or on the hard disk 250, the CPU 210 also functions as an acquisition module 212, a shared key generation module 214, an authentication process module 216, and an encryption key generation module 218, and carries out a shared key generation process and an encryption key generation process, discussed later.

The acquisition module 212 acquires the unique information inclusive of the unique number and update information, that was read by the RFID reader 10A. The shared key generation module 214 uniquely generates a shared key (PMK: Pairwise Master Key) on the basis of the unique information acquired by the acquisition module 212. Using the same conversion function as the shared key generation module 114 in the access point 100 described previously, the shared key generation module 214 generates a shared key. The shared key generated by the shared key generation module 214 is then saved to the hard disk 250. In FIG. 3, a shared key PMKa, which is generated on the basis of unique information read from the RFID tag 310A of the RFID card 300A, is saved.

Prior to encrypted communication between the wireless terminal 200A and the access point 100, the authentication process module 216 exchanges packets containing the shared key, and performs an authentication process using the shared key as authentication information. In case where the wireless terminal 200A and the access point 100 possess identical shared keys, authentication is successful. When authentication is successful, the encryption key generation module 218 generates an encryption key on the basis of its own shared key, the MAC address of the access point 100, the SSID (Service Set Identifier), or the like.

### A4. Shared Key Setup Process:

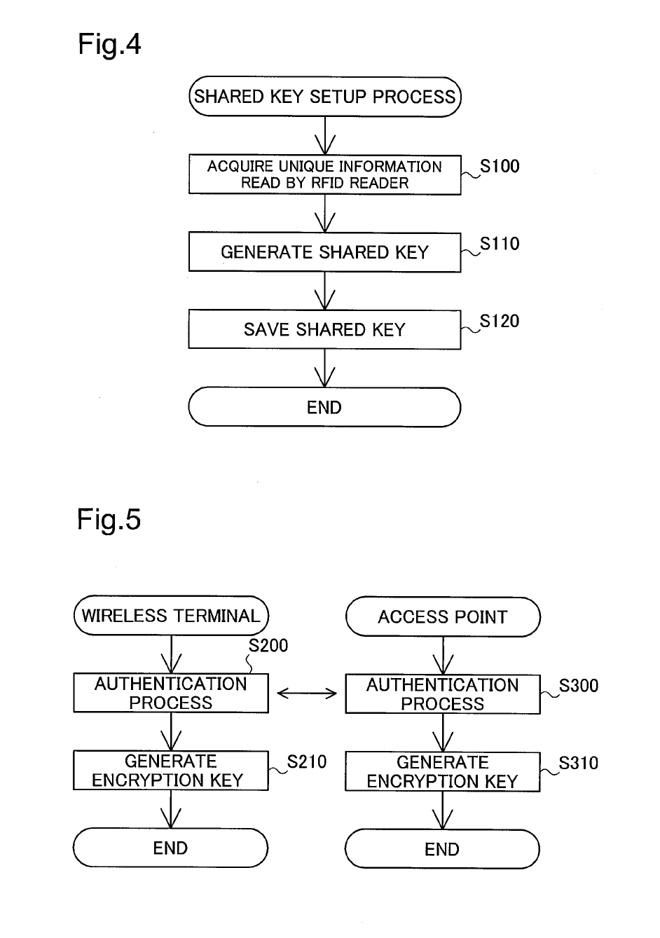

FIG. 4 is a flowchart depicting the flow of a shared key setup process. This process is one in which the CPU 110 of the access point 100 and the CPU 210 of the wireless terminal (wireless terminal 200A or 200B) set up a shared key to be used as a basis for generating an encryption key for use in encrypted communications. The description here relates to the process executed by the CPU 110 of the access point 100.

First, the acquisition module 112, which is the function module of the CPU 110 (See FIG. 2), acquires unique information that was read by the RFID reader 10 and that contains a unique number and update information (Step S100). Next, as described previously, the shared key generation module 114 uniquely generates a shared key on the basis of the unique information acquired by the acquisition module 112 (Step S110). This shared key is saved to the storage device 150 (Step S120). The shared key setup process then terminates. The above process is executed analogously by the CPU 210 (i.e. the acquisition module 212 and the shared key generation module 214) of the wireless terminal 200A (or the wireless terminal 200B). In this way, identical shared keys can be set up in the access point 100 and in the wireless terminal 200A (or the wireless terminal 200B).

FIG. 5 is a flowchart depicting the flow of an encryption key setup process. Processes taking place in the wireless terminal 200A (or the wireless terminal 200B) are shown at left in FIG. 5, and processes taking place in the access point 100 are shown at right in FIG. 5. The discussion here assumes that identical shared keys were already set up in the access point 100 and in the wireless terminal 200A (or the wireless terminal 200B) by the shared key setup process described above.

First, the authentication process module 216 of the wireless terminal 200A (or the wireless terminal 200B) and the authentication process module 116 of the access point 100 carry out an authentication process by the 4-Way-Handshake protocol (Step S200, Step S300). Exchange of the shared key by the wireless terminal 200A (or the wireless terminal 200B) and the access point 100 during the authentication process takes place by EAPOL-Key (EAPOL: Extensible Authentication Protocol over LAN) exchange.

Next, the wireless terminal 200A (or the wireless terminal 200B) generates an encryption key on the basis of its shared key, the MAC address of the access point 100, the SSID, etc. (Step S210). The access point 100 likewise generates an encryption key on the basis of its shared key (which is identical to the shared key belonging to the wireless terminal 200A (or the wireless terminal 200B)), the MAC address of the access point 100, the SSID, etc. (Step S310). The encryption key setup process then terminates. Through the above process, common encryption keys may be set up in the access point 100 and in the wireless terminal 200A (or the wireless terminal 200B). Encrypted communication may then take place using the common encryption keys that were set up respectively in the wireless terminal 200A (or the wireless terminal 200B) and in the access point 100.

According to the wireless communication system 1000 of the present embodiment described above, the access point 100 and the wireless terminals 200A, 200B uniquely generate shared keys on the basis of unique information that is read from the RFID tag 310A of the existing RFID card 300A or the RFID tag 310B of the RFID 300B; authentication is carried out using the shared keys as authentication information; and if authentication is successful, an encryption key is generated on the basis of at least the shared key, and this encryption key is then set up as the encryption key for encrypted communication. Thus, setting up the encryption key in the access point 100 and in the wireless terminals 200A, 200B may be accomplished using existing RFID cards and relatively inexpensive RFID readers 10, 10A, 10B as hardware, making it unnecessary to provide special RFID tags for encryption key setup or an RFID writer for writing the encryption key to the RFID tags. Additionally, there is no need to transfer the encryption key between the access point 100 and the wireless terminals 200A, 200B through wireless space. Also, the user does not need to manually set up the encryption key in the access point 100 and the wireless terminals 200A, 200B. Accordingly, in the wireless communication system 1000 of the present embodiment it is possible to readily set up an encryption key for use in encrypted communication, while minimizing the cost burden on the user and while maintaining security.

In the wireless communication system 1000 of the present embodiment, RFID tags used for an existing service that employs the RFID tags are utilized as the RFID cards 300A, 300B, and thus the update information included in the unique information stored in each RFID tag is updated each time that the service is used. Consequently, in the wireless communication system 1000 of the present embodiment, shared keys and encryption keys belonging to the access point 100 and to the wireless terminals 200A, 200B may be updated frequently. The security of wireless communication between the access point 100 and the wireless terminals 200A, 200B may be improved as a result.

### B. Second Embodiment

### B1. Wireless Communication System Features:

The hardware configuration of the wireless communication system of the second embodiment (not shown) is the same as the hardware configuration of the wireless communication system 1000 of the first embodiment. However, the wireless communication system of the second embodiment includes an access point 100A in place of the access point 100 in the wireless communication system 1000 of the first embodiment. The shared key generation process executed by the access point 100A differs in part from the shared key generation process executed by the access point 100. The features of the access point 100A and the shared key setup process are described below.

### B2. Access Point Features:

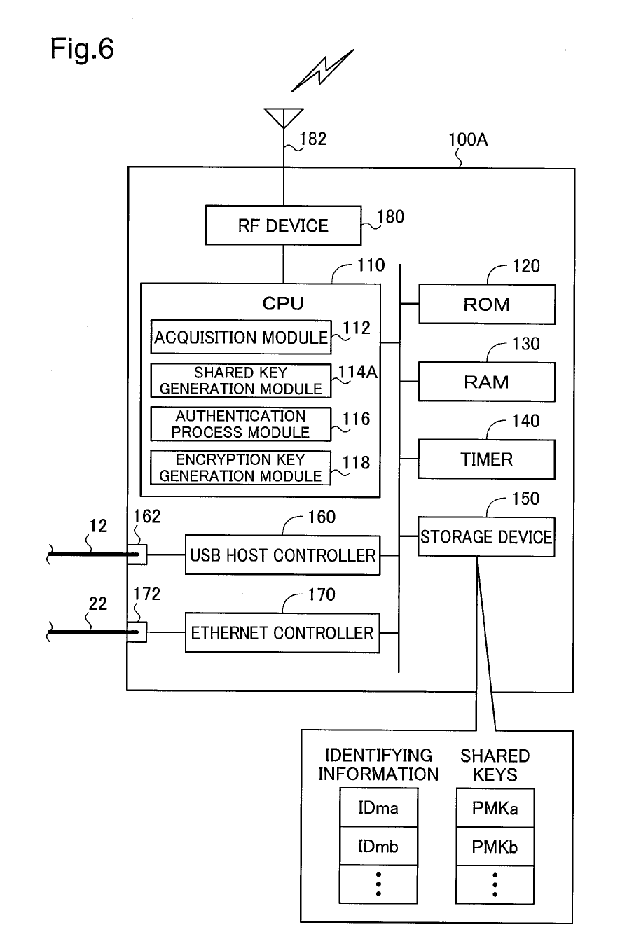

FIG. 6 depicts general features of the access point 100A. As will be appreciated by comparing FIG. 6 and FIG. 2, the CPU 110 of the access point 100A has a shared key generation module 114A in place of the shared key generation module 114 in the CPU 110 of the access point 100. Manufacture IDs (identifying information) of RFID tags authorized to generate shared keys are registered beforehand in the storage device 150. For example, the access point 100A may be provided with a computer program for registering manufacture IDs of RFID tags, and with a control button for running the computer program; the administrator of the access point 100A would then operate the control button to read out with the RFID reader 10 the manufacture ID of an RFID tag that is authorized to generate shared keys, and register the manufacture ID. In FIG. 6, the manufacture ID (IMDa) stored in the RFID tag 310A of the RFID card 300A and the manufacture ID (IMDb) stored in the RFID tag 310B of the RFID card 300B are shown registered as manufacture IDs of RFID tags that are authorized to generate shared keys. If the manufacture ID contained in the unique information acquired by the acquisition module 112 is registered as a manufacture ID authorized to generate shared keys, the shared key generation module 114A generates a shared key. On the other hand, if the manufacture ID contained in the unique information acquired by the acquisition module 112 is not registered as a manufacture ID authorized to generate shared keys, the shared key generation module 114A does not generate a shared key. In this instance, the CPU 110 activates an alert portion such as an LED or buzzer (not shown) to alert the user that the manufacture ID contained in the unique information that was acquired by the acquisition module 112 is not yet registered as a manufacture ID authorized to generate shared keys, i.e. that a shared key cannot be generated.

### B3. Shared Key Setup Process:

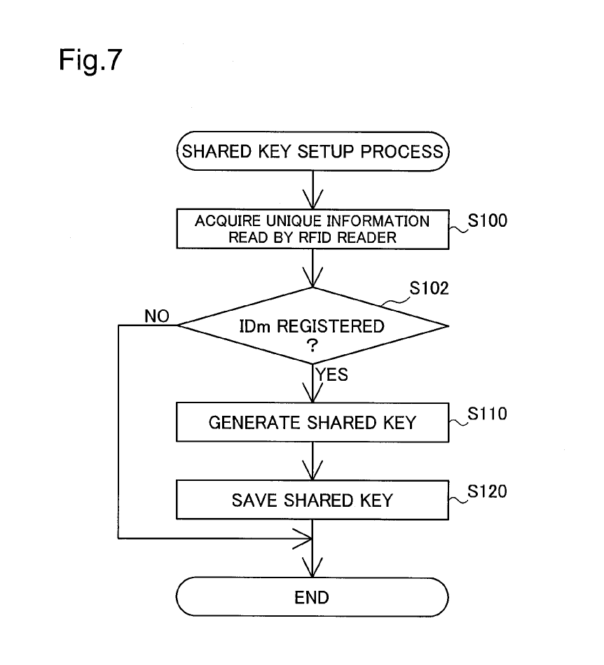

FIG. 7 is a flowchart depicting the flow of a shared key setup process. This process is one in which the CPU 110 of the access point 100A sets up a shared key to be used as a basis for generating an encryption key for use in encrypted communication.

First, the acquisition module 112 acquires unique information that was read by the RFID reader 10 and that contains a unique number and update information (Step S100). Next, the shared key generation module 114A decides whether the manufacture ID (IDm) contained in the unique information that was acquired by the acquisition module 112 is registered as a manufacture ID that is authorized to generate shared keys (Step S102). If the manufacture ID (IDm) contained in the unique information that was acquired by the acquisition module 112 is not registered as a manufacture ID authorized to generate shared keys (Step S102: NO), the shared key generation module 114A terminates the shared key setup process without generating a shared key. At this point, the CPU 110 activates the alert portion and notifies the user that a shared key could not be generated. On the other hand, if the manufacture ID (IDm) contained in the unique information that was acquired by the acquisition module 112 is registered as a manufacture ID authorized to generate shared keys (Step S102: YES), the shared key generation module 114A uniquely generates a shared key on the basis of the unique information acquired by the acquisition module 112 (Step S110) and saves this shared key to the storage device 150 (Step S120), in the manner described earlier. The shared key setup process then terminates.

According to the wireless communication system of the second embodiment described above, like the wireless communication system 1000 of the first embodiment, it is possible to readily set up an encryption key for use in encrypted communication, while minimizing the cost burden on the user and maintaining security.

In the wireless communication system of the second embodiment, during the shared key setup process, if the manufacture ID contained in acquired unique information is not registered as the manufacture ID of an RFID tag that is authorized to generate shared keys, the access point 100A does not generate a shared key and does not generate an encryption key, and thus RFID tags enabled to set up encryption keys can be limited to those RFID tags having a previously registered manufacture ID. In other words, only a user possessing an RFIG tag whose manufacture ID has been previously registered can access the wireless communication system of the second embodiment. The security of wireless communications can be enhanced as a result.

### C. Third Embodiment

### C1. Wireless Communication System Features:

The hardware configuration of the wireless communication system of the third embodiment (not shown) is the same as the hardware configuration of the wireless communication system 1000 of the first embodiment. However, the wireless communication system of the third embodiment includes an access point 100B in place of the access point 100 in the wireless communication system 1000 of the first embodiment. The shared key generation process executed by the access point 100B differs in part from the shared key generation process executed by the access point 100. The features of the access point 100B and the shared key setup process are described below.

### C2. Access Point Features:

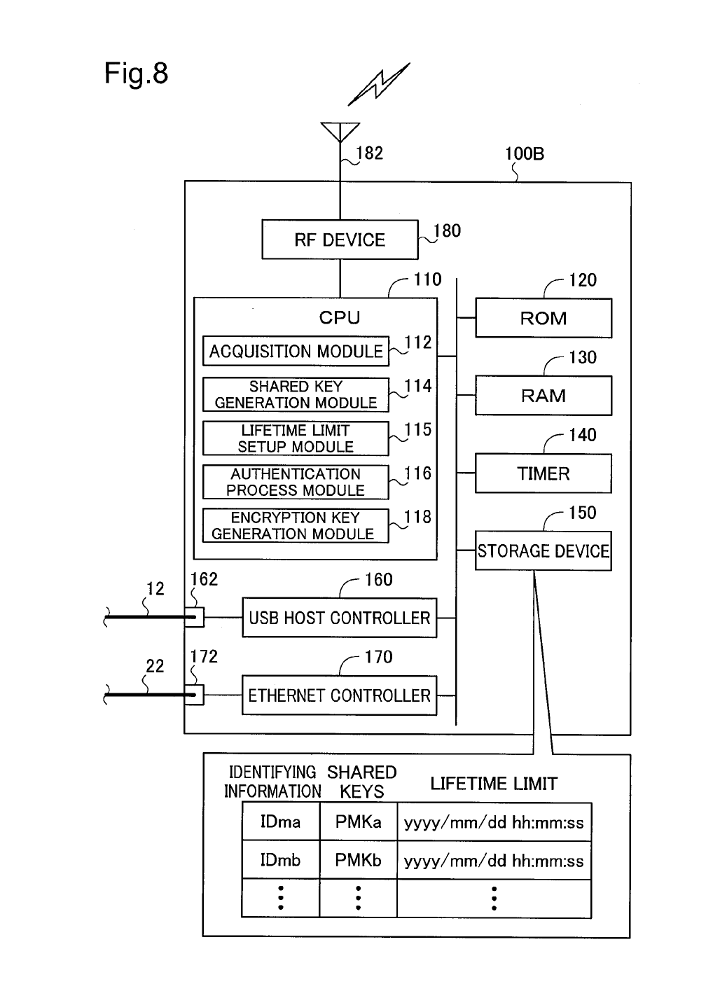

FIG. 8 depicts general features of the access point 100B. As will be appreciated by comparing FIG. 8 and FIG. 2, the CPU 110 of the access point 100B is similar in configuration to the CPU 110 of the access point 100 but is additionally provided with a lifetime limit setup module 115 for setting up a lifetime limit for shared keys. The storage device 150 stores shared keys generated by the shared key generation module 114, in association with the lifetime that established by the lifetime limit setup module 115, and manufacture IDs (identifying information) contained in unique information that was acquired by the acquisition module 112. Once the lifetime limit for a shared key stored in the storage device has expired, it is destroyed. A feature comparable to the lifetime limit setup module 115 of the access point 100B may be implemented in the wireless terminals 200A, 200B as well.

### C3. Shared Key Setup Process:

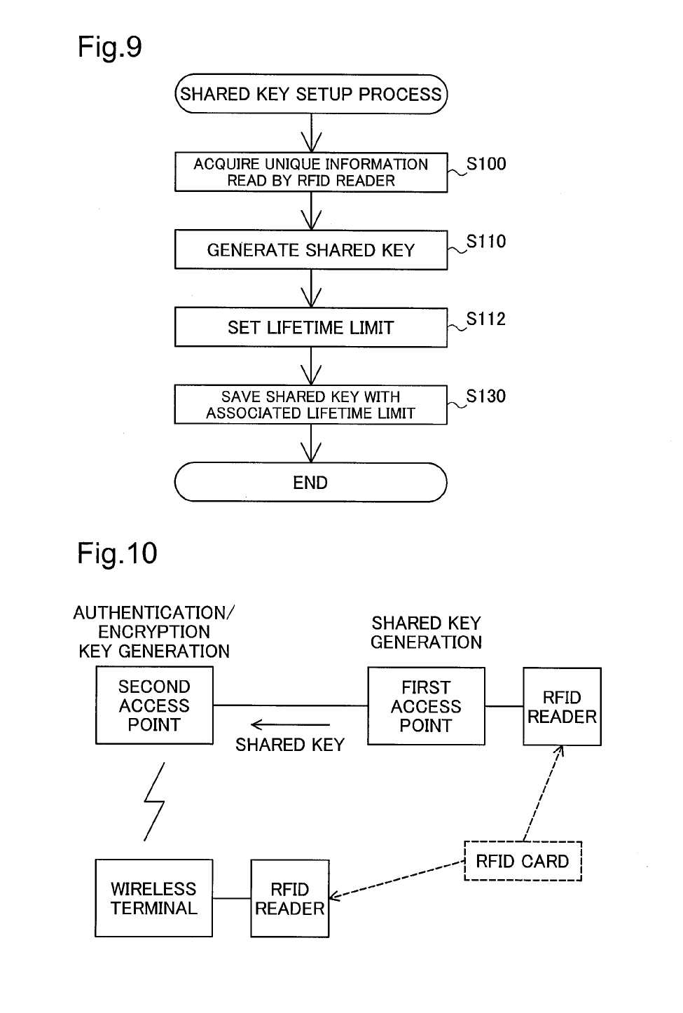

FIG. 9 is a flowchart depicting the flow of a shared key setup process. This process is one in which the CPU 110 of the access point 100B sets up a shared key to be used as a basis for generating an encryption key for use in encrypted communication.

First, the acquisition module 112 acquires unique information that was read by the RFID reader 10 and that contains a unique number and update information (Step S100). Next, as described previously, the shared key generation module 114 uniquely generates a shared key on the basis of the unique information acquired by the acquisition module 112 (Step S110). The lifetime limit setup module 115 then sets up a lifetime limit for the shared key that was generated (Step S112). The lifetime limit for the shared key may be set arbitrarily, for example, to extend for 24 hours from the time that the shared key is generated, or until 12:00 AM on the day following that on which the shared key is generated. The shared key generation module 114A then saves the shared key, with the associated lifetime limit and identifying information, to the storage device 150 (Step S130). The shared key setup process then terminates.

According to the wireless communication system of the third embodiment described above, like the wireless communication system 1000 of the first embodiment, it is possible to readily set up an encryption key for use in encrypted communication, while minimizing the cost burden on the user and maintaining security.

In the wireless communication system of the third embodiment, during the shared key generation process the access point 100B sets up a lifetime limit for the shared key, making it possible to limit the period for which the shared key can be used. In order to continue encrypted communication using the access point 100B, the user must perform an operation such as prompting the access point 100B to again generate a shared key and an encryption key so that a new shared key and an encryption key are generated in the access point 100B. Security of wireless communications can be enhanced as a result.

### D. Modified Examples:

While the invention is disclosed above in terms of certain preferred embodiments, it is to be understood that there is no intention to limit the invention to the embodiments disclosed herein, and that various other modes are possible within the spirit and scope of the invention. Modifications such as the following are possible, for example.

### D1. First Modified Example:

In the preceding embodiments, the RFID tags used for setup of shared keys and encryption keys are RFID tags (FeliCa) a portion of whose retained information (update information) is updated each time that an existing service that employs the RFID tag is accessed; however, the present invention is not limited to such an arrangement. RFID tags whose retained information is not updated may be employed as well. The RFID tag standard is not limited to FeliCa, and other standards such as Mifare ™ could be used. RFID tags need not be compliant with the NFC standard.

### D2. Second Modified Example:

In the preceding embodiments, the access point 100, 100A, 100B and the wireless terminals 200A, 200B generate shared keys of 512-bit key length, but key length may be selected arbitrarily depending on required key strength.

### D3. Third Modified Example:

The features of the access point 100A of the second embodiment may be combined with the features of the access point 100B of the third embodiment. Specifically, according to this arrangement, the CPU 110 of the access point is provided with the acquisition module 112, the shared key generation module 114A, the lifetime limit setup module 115, the authentication process module 116, and the encryption key generation module 118; manufacture IDs that are authorized to generate shared keys are saved beforehand in the storage portion 150; and shared keys are stored in association with lifetime limits. With this arrangement it is possible to limit the RFID tags that are authorized to set up encryption, as well as to limit the interval for which a shared key can be used, thereby enhancing security of wireless communications.

### D4. Fourth Modified Example:

In the preceding embodiments, the RFID reader is connected to the access point or to the wireless terminal, but the invention is not limited to such an arrangement. The access point or to the wireless terminal may instead have an internal RFID reader.

### D5. Fifth Modified Example:

In the preceding first embodiment, a single access point 100 is furnished with the acquisition module 112, the shared key generation module 114, the authentication process module 116, and the encryption key generation module 118, but the invention is not limited to such an arrangement. The functions of the acquisition module 112, the shared key generation module 114, the authentication process module 116, and the encryption key generation module 118 could instead be distributed among several access points. This applies to the access point 100A of the second embodiment and the access point 100B of the third embodiment as well.

FIG. 10 depicts general features of a wireless communication system as a modified example. The wireless communication system of this modified example includes a first access point, a second access point, and a wireless terminal. An RFID reader is connected to the first access point, and there is a wired connection between the first access point and the second access point. While not shown in the drawing, the first access point includes the acquisition module 112 and the shared key generation module 114 described above, while the second access point includes the authentication process module 116 and the encryption key generation module 118 described above.

The first access point generates a shared key on the basis of unique information read from an RFID card by the RFID reader connected to the first access point. The shared key is then transmitted to the second access point over the wired connection. The wireless terminal likewise generates a shared key on the basis of unique information read from an RFID card by the RFID reader that is connected to the wireless terminal. Identical shared keys are set up in the second access point and the wireless terminal at this time. The second access point and the wireless terminal then authenticate using the shared keys. In the event of successful authentication, on the basis of the retained shared key etc. the second access point and the wireless terminal generate an encryption key for encrypted communication between them. Through this arrangement, as in the preceding embodiments, it is possible to readily set up an encryption key for use in encrypted communication, while minimizing the cost burden on the user and maintaining security.

In an alternative arrangement of the present modified example, the second access point transmits the generated encryption key to the first access point over the wired connection. The wireless terminal may thus carry out encrypted communication with both the first access point and the second access point.

Alternatively, the first access point may include the acquisition module 112 described above, while the second access point includes the shared key generation module 114, the authentication process module 116 and the encryption key generation module 118 described above. In this case the second access point would receive unique information sent to it by the first access point over the wired connection, and would then carry out generation of a shared key, authentication, and generation of an encryption key.

In yet another alternative arrangement, the first access point may include the acquisition module 112, the shared key generation module 114, the authentication process module 116 and the encryption key generation module 118 described above, and then send the generated encryption key to the second access point over the wired connection. Alternatively, an RFID reader may be connected to the second access point as well; both the first access point and the second access point may include the acquisition module 112, the shared key generation module 114, the authentication process module 116 and the encryption key generation module 118 described above; and the devices may appropriately send and receive to each other at least one of unique information, a shared key, or an encryption key. Such arrangements can offer improved convenience to users of a wireless LAN in which several access points are interconnected.

### D6. Sixth Modified Example:

In the preceding embodiments, the access point 100 for example is furnished with the acquisition module 112, the shared key generation module 114, the authentication process module 116, and the encryption key generation module 118, but the invention is not limited to such an arrangement. For example, the functions of the acquisition module 112 and the shared key generation module 114 may be provided to another device having a wired connection to the access point, while the access point is provided with the authentication process module 116 and the encryption key generation module 118. In this case, the other device would carry out the shared key setup process described above, and the access point would then acquire the shared key generated by the other device, and carry out the authentication process and encryption key setup process described above.

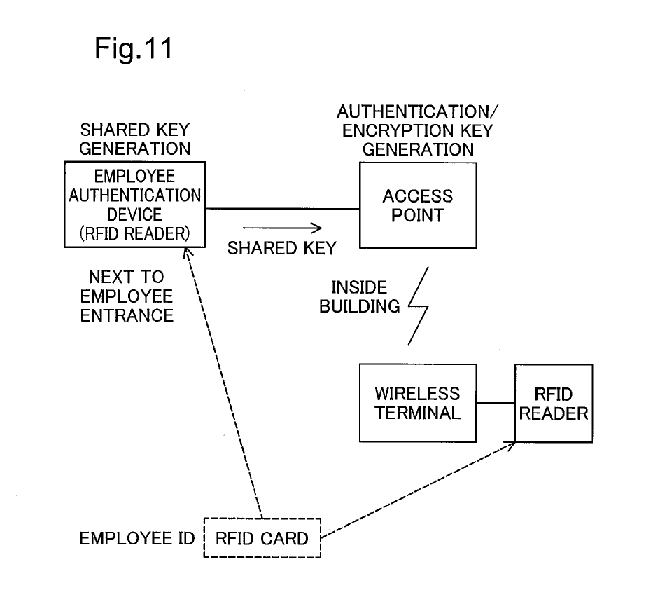

FIG. 11 depicts general features of a wireless communication system as a modified example. The wireless communication system of this modified example includes an access point, an employee authentication device, and a wireless terminal. The employee authentication device is situated close to an employee entrance of a company, and on the basis of unique information read by an RFID reader from RFIF cards provided as employee ID decides whether the holder of an RFIF card has permission to enter the office. The access point and the wireless terminal are located inside the office, and there is a wired connection between the access point and the employee authentication device. While not shown in the drawing, the employee authentication device includes the acquisition module 112 and the shared key generation module 114 described previously, while the access point includes the authentication process module 116 and the encryption key generation module 118 described previously.

If the holder of an RFID card has permission to enter the office, the employee authentication device generates a shared key on the basis of unique information read from the RFID card by an RFID reader. This shared key is sent to the access point over the wired connection. The wireless terminal likewise generates a shared key on the basis of unique information read from the RFID card by an RFID reader connected to the wireless terminal. Identical shared keys are set up in the access point and the wireless terminal at this time. The access point and the wireless terminal then authenticate using the shared keys. In the event of successful authentication, the access point and the wireless terminal, on the basis of the retained shared key etc., generate an encryption key for encrypted communication between them. Through this arrangement, as in the preceding embodiments, it is possible to readily set up an encryption key for use in encrypted communication, while minimizing the cost burden on the user and maintaining security.

### D7. Seventh Modified Example:

The wireless communication system 1000 of the preceding embodiments may include a wired LAN in addition to a wireless LAN. The wired LAN may be provided with a network device such as a switching hub for example. In this case, the authentication method using RFID tags and RFID readers described above may be deployed for the purpose of authenticating connections in a switching hub or VPN (Virtual Private Network) for example. Specifically, like the access point 100 in the preceding embodiment, the network device is provided with an acquisition portion for acquiring unique information read from RFID tags (corresponding to the acquisition module 112 in the access point 100 for example), an authentication information generation portion for generating on the basis of the unique information authentication information used to authenticate with other network devices (corresponding to the shared key generation module 114 in the access point 100 for example), an authentication information storage portion for storing authentication information (corresponding to the storage device 150 in the access point 100 for example), and an authentication process portion for carrying out authentication with other network devices using the authentication information (corresponding to the authentication process module 116 in the access point 100 for example).

### D8. Eighth Modified Example:

Some of the features implemented through hardware in the preceding embodiments could be replaced by software, and conversely some of the features implemented through software could be replaced by hardware.

### D9. Ninth Modified Example:

The Program product may be realized as many aspects. For example:

(i) Computer readable medium, for example the flexible disks, the optical disk, or the semiconductor memories;

(ii) Computer including the computer readable medium, for example the magnetic disks or the semiconductor memories; and

(iii) Computer temporally storing the computer program in the memory through the data transferring means.

While the invention has been described with reference to preferred exemplary embodiments thereof, it is to be understood that the invention is not limited to the disclosed embodiments or constructions. On the contrary, the invention is intended to cover various modifications and equivalent arrangements. In addition, while the various elements of the disclosed invention are shown in various combinations and configurations, which are exemplary, other combinations and configurations, including more less or only a single element, are also within the spirit and scope of the invention.

### E. Variations:

The present invention may be addressed according to the following aspects of the invention.

First aspect

According to a first aspect of the invention, there is provided:

a wireless communication device comprising:

an acquisition portion which acquires prescribed information read from an RFID (Radio Frequency Identification) tag that retains unique information;

a shared key generation portion which uniquely generates based on the prescribed information a shared key serving as a basis to generate an encryption key for use in encrypted communication with another wireless communication device;

a shared key storage portion which stores the shared key;

an authentication process portion which carries out authentication between the wireless communication device and the another wireless communication device, using the shared key as authentication information;

an encryption key generation portion which generates the encryption key based on at least the shared key, in the event that authentication by the authentication process portion is successful; and

a communication portion which carries out encrypted communication using the encryption key.

The wireless communication device according to the first aspect is embodied in an access point or wireless terminal in a wireless LAN. In the wireless communication device of the first aspect, a shared key is uniquely generated on the basis of unique information read from an existing RFID tag, and authentication of other wireless communication devices is carried out using this shared key as authentication information; if authentication is successful, an encryption key is generated on the basis of at least this shared key, and this encryption key can then be set up as the encryption key for encrypted communication. It is therefore unnecessary to provide special RFID tags for encryption key setup or an RFID writer for writing the encryption key to the RFID tags, in order to set up an encryption key in wireless communication devices. Additionally, there is no need to transfer the encryption key among wireless communication devices through wireless space. Also, the user does not need to manually set up the encryption key in a wireless communication device. Accordingly, with the wireless communication device of the first aspect it is possible to readily set up an encryption key for the purpose of encrypted communication with other wireless communication devices, while minimizing the cost burden on the user and while maintaining security.

In the wireless communication device according to the first aspect, if authentication by the authentication portion fails, the encryption key generation portion does not generate an encryption key. The existing RFID mentioned above refers to an RFID tag originally used for some purpose other than generating a shared key in the wireless communication device or setting up an encryption key in the wireless communication device. Examples of such RFID tags include RFID tags in chip-embedded train tickets, electronic debit cards, club membership cards, retailer rewards cards, employee ID cards, or cell phones.

Second aspect

According to a second aspect of the invention, there is provided:

the wireless communication device according to the first aspect wherein

the RFID tag is one in which some of the prescribed information retained by the RFID tag is updated by an RFID writer each time that the RFID tag is used for a purpose other than generating the shared key in the wireless communication device.

As memory areas for storing the unique information, the RFID tag is provided with a memory area for saving a unique number assigned exclusively to that individual RFID tag, and a memory area for saving information updatable by an RFID writer. For example, in the RFID tag in a prepaid electronic debit card, the updatable information is updated each time that the electronic debit service is used. Thus, according to the wireless communication device of the second aspect, the shared key and the encryption key can be updated frequently. Security is enhanced as a result.

Third aspect

According to a third aspect of the invention, there is provided:

the wireless communication device according to aspect 1 or 2 wherein

the prescribed information includes identifying information by which the RFID tag is identifiable;

the wireless communication device further includes an identifying information registration portion having the identifying information preregistered therein; and

prior to generation of the shared key, the shared key generation portion generates the shared key in the event that the identifying information included in the prescribed information is registered in the identifying information registration portion, and does not generate the shared key in the event that the identifying information included in the prescribed information is not registered in the identifying information registration portion.

According to the wireless communication device of the third aspect, RFID tags authorized to set up encryption keys can be limited to those RFID tags whose identifying information was previously registered in the identifying information registration portion.

Fourth aspect

According to a fourth aspect of the invention, there is provided:

the wireless communication device according to any of the first to third aspects further comprising:

a lifetime limit setup portion which sets a lifetime limit for the shared key;

wherein the shared key storage portion stores the shared key in association with the lifetime limit.

According to the wireless communication device of the fourth aspect, it is possible to limit the period for which the shared key can be used. At that point, in order to continue encrypted communication by the wireless communication device, the user must update the shared key. Specifically, it is necessary to generate a new shared key and encryption key in the wireless communication device. Security is enhanced as a result. Upon expiration the shared key is no longer valid, and is destroyed for example.

Fifth aspect

According to a fifth aspect of the invention, there is provided:

a wireless communication system for carrying out encrypted communication between a first wireless communication device and a second wireless communication device, wherein

the first and second wireless communication devices respectively include:

an acquisition portion which acquires prescribed information read from an RFID (Radio Frequency Identification) tag that retains unique information;

a shared key generation portion which uniquely generates based on the prescribed information a shared key serving as a basis to generate an encryption key for use in the encrypted communication;

a shared key storage portion which stores the shared key;

an authentication process portion which carries out authentication between present wireless communication device and another wireless communication device, using the shared key as authentication information;

an encryption key generation portion which generates the encryption key based on at least the shared key, in the event that authentication by the authentication process portion is successful; and

a communication portion which carries out encrypted communication using the encryption key.

The various supplemental elements described above may be implemented appropriately in at least one of the first and second wireless communication devices in the wireless communication system of the fifth aspect.

Sixth aspect

According to a sixth aspect of the invention, there is provided:

a network device comprising:

an acquisition portion which acquires prescribed information read from an RFID (Radio Frequency Identification) tag that retains unique information;

an authentication information generation portion which generates based on the prescribed information authentication information for use in authentication of the network device and another network device;

an authentication information storage portion which stores the authentication information; and

an authentication process portion which carries out the authentication using the authentication information.

The network device of the sixth aspect may be implemented in authentication of connections in switching hub or a VPN (Virtual Private Network) for example. According to the network device of the sixth aspect, authentication information is uniquely generated on the basis of unique information read from an existing RFID tag, and authentication of other wireless communication devices is carried out using this authentication information. It is therefore unnecessary to provide a special RFID tag for authentication information setup or an RFID writer for writing authentication information to the RFID tag, in order to set up authentication information in the network device. Also, the user does not need to perform a manual operation to set up the authentication information in the network device. Accordingly, with the network device of the sixth aspect it is possible to readily set up authentication information for the purpose of authentication of other network devices, while minimizing the cost burden on the user and while maintaining security.

What is claimed is:

1. A wireless communication device comprising:
a processing unit;
a memory system;
a plurality of modules wherein said modules can comprise one of a software module and a hardware module, said plurality of modules comprising;
an acquisition module which acquires prescribed information read from an RFID (Radio Frequency Identification) tag that retains unique information;
a shared key generator which uniquely generates a shared key based on the prescribed information, the shared key serving as a basis for generation of an encryption key for use in encrypted communication with another wireless communication device, the prescribed information includes identifying information by which the RFID tag is identifiable;
a shared key storage module which stores the shared key;
an authentication processing module which carries out authentication between the wireless communication device and the another wireless communication device, using the shared key as authentication information;
an encryption key generator which generates the encryption key based on at least the shared key, in the event that authentication by the authentication process module is successful; and
a communication module which carries out encrypted communication using the encryption key;
an identifying information registration module having the identifying information preregistered therein; and
prior to generation of the shared key, the shared key generator generates the shared key in the event that the identifying information included in the prescribed information is registered in the identifying information registration module, and does not generate the shared key in the event that the identifying information included in the prescribed information is not registered in the identifying information registration module.

2. A wireless communication device comprising:
a processing unit;
a memory system;
a plurality of modules wherein said modules can comprise one of a software module and a hardware module, said plurality of modules comprising;
an acquisition module that enables acquisition of prescribed information read from an RFID (Radio Frequency Identification) tag that retains unique information;
a shared key generator which uniquely generates a shared key based on the prescribed information, the shared key serving as a basis for generating an encryption key for use in encrypted communication with another wireless communication device;
a lifetime limit setup module which sets a lifetime limit for the shared key;
a shared key storage module which stores the shared key in association with the lifetime limit;
an authentication process module which carries out authentication between the wireless communication device and the another wireless communication device, using the shared key as authentication information;
an encryption key generator which generates the encryption key based on at least the shared key, in the event that authentication by the authentication process module is successful; and
a communication module which carries out encrypted communication using the encryption key.

3. The wireless communication device according to claim 1 wherein
the RFID tag is one in which some of the prescribed information retained by the RFID tag is updated by an RFID writer each time that the RFID tag is used for a purpose other than generating the shared key in the wireless communication device.

4. The wireless communication device according to claim 2 wherein
the RFID tag is one in which some of the prescribed information retained by the RFID tag is updated by an RFID writer each time that the RFID tag is used for a purpose other than generating the shared key in the wireless communication device.

5. A wireless communication system for carrying out encrypted communication between a first wireless communication device and a second wireless communication device, wherein
the first and second wireless communication devices each include:
a processing unit;
a memory system;
an acquisition module which acquires prescribed information read from an RFID (Radio Frequency Identification) tag that retains unique information and wherein the prescribed information includes identifying information by which the RFID tag is identifiable;
a shared key generator which uniquely generates based on the prescribed information a shared key serving as a basis to generate an encryption key for use in the encrypted communication;
a shared key storage module which stores the shared key;
an authentication process module which enables authentication between present wireless communication device and another wireless communication device, using the shared key as authentication information;
an encryption key generator which generates the encryption key based on at least the shared key, in the event that authentication by the authentication process module is successful; and
a communication module which carries out encrypted communication using the encryption key;
an identifying information registration module having the identifying information preregistered therein; and
the system arranged such that, prior to generation of the shared key, the shared key generation module generates the shared key in the event that the identifying information included in the prescribed information is registered in the identifying information registration module, and does not generate the shared key in the event that the identifying information included in the prescribed information is not registered in the identifying information registration module.

6. A wireless communication system for carrying out encrypted communication between a first wireless communication device and a second wireless communication device, wherein
the first and second wireless communication devices each include:
a processing unit;
a memory system;
an acquisition module which acquires prescribed information read from an RFID (Radio Frequency Identification) tag that retains unique information;
a shared key generator which uniquely generates, based on the prescribed information, a shared key that serves as a basis for generating an encryption key for use in the encrypted communication;
a lifetime limit setup module which sets a lifetime limit for the shared key;
a shared key storage module which stores the shared key in association with the lifetime limit;
an authentication process module which carries out authentication between a present wireless communication device and another wireless communication device, using the shared key as authentication information;
an encryption key generator which generates the encryption key based on at least the shared key, in the event that authentication by the authentication process module is successful; and
a communication module which carries out encrypted communication using the encryption key.
